(19) United States
(12) Patent Application Publication
(10) Pub. No.: US 2007/0228946 A1
(43) Pub. Date: Oct. 4, 2007

(54) IMAGE DISPLAY DEVICE

(76) Inventors: Hirotaka Murata, Fukaya-shi (JP); Keiji Suzuki, Yokohama-shi (JP); Yoshiyuki Kitahara, Fujisawa-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/758,686

(22) Filed: Jun. 6, 2007

Related U.S. Application Data
(63) Continuation of application No. PCT/JP05/22355, filed on Dec. 6, 2005.

(30) Foreign Application Priority Data
Dec. 10, 2004 (JP) 2004-358866

(51) Int. Cl. H01J 1/62

(52) U.S. Cl. 313/505

(57) ABSTRACT

In an image display device which comprises a front plate having phosphor layers, resistance layers formed between the phosphor layers, a matal back layer which is formed on the phosphor layers and the resistance layers and segmented into regions by gaps in a first direction X perpendicular to the scanning direction for image display and by gaps on the resistance layers in a second direction Y which coincides with the scanning direction for image display, and high-voltage supplier which applies a high voltage to the matal back layer, and a back plate which is set opposite to the front plate and has a number of electron emitting elements arranged on it, characterized in that the resistance layer present between each region segmented by the gaps is discretely formed in its portions with low-resistance regions which are relatively lower in resistance than the other portions.

### CROSS-REFERENCE TO RELATED APPLICATIONS

This is a Continuation Application of PCT Application No. PCT/JP2005/022355, filed Dec. 6, 2005, which was published under PCT Article 21(2) in Japanese.

This application is based upon and claims the benefit of priority from prior Japanese Patent Application No. 2004-358866, filed Dec. 10, 2004, the entire contents of which are incorporated herein by reference.

### BACKGROUND OF THE INVENTION

1. Field of the Invention

The present invention relates to an image display device using electron emitting elements and more particularly to a technique to suppress discharge current at the occurrence of discharge.

2. Description of the Related Art

In recent years, as a next-generation image display device, a flat-panel image display device has been being developed in which a large number of electron emitting devices are arranged opposite to a phosphor screen. There are various types of electron emitting elements. Basically, all of these elements employ field emission. A display device using these electron emitting elements is generally referred to as a field emission display (hereinafter referred to as an FED). Of the FEDs, a display device using surface-conduction electron emitting elements is referred to as a surface-conduction electron-emitter display (hereinafter referred to as an SED). In this specification, the term “FED” is used as a generic name including the SED.

The FED, as described in JP-A No. 10-326583 (KOKAI), has a front plate and a back plate which are opposed to each other with a small gap of the order of 1-2 mm therebetween. These plates have their peripheral portions bonded together through a sidewall in the shape of a rectangular frame to form a vacuum vessel. The inside of the vacuum vessel is maintained at a high degree of vacuum of less than about 10⁻⁴ Pa. In order to support the atmospheric load applied to the back and front plates, a number of spacers is set between the plates.

The front plate is formed on its inside surface with a phosphor screen including phosphor layers of red, blue, and green. The back plate is formed on its inside surface with a large number of electron emitting elements to emit electrons which excite phosphors to cause them to emit light. A large number of scanning and signal lines is formed in a matrix form and connected to the electron emitting elements. The phosphor screen is impressed with an anode voltage by which electrons emitted from the electron emitting elements are accelerated to strike the phosphor screen, whereby the phosphors emit light to display an image.

With the FED constructed as described above, in order to obtain practical display characteristics, it is required to use the same phosphors as in ordinary cathode ray tubes and moreover a phosphor screen in which a thin film of aluminum called metal backing is formed on the phosphors. In this case, it is desired that the anode voltage applied to the phosphor screen be set to several kilovolts at a minimum, higher than 10 kV if possible.

However, the gap between the front and back plates cannot be made so large from a viewpoint of resolution and spacer characteristics and must be set to about 1-2 mm. With the FED, therefore, it is inevitable that a strong electric field is formed across the small gap between the front and back plates, and discharge between the plates becomes a problem.

If no provision is made for suppression of discharge damages, discharge will destroy or degrade the electron emitting elements, the phosphor screen, driver ICs, and drive circuits. We shall collectively refer to these destroy or degrade as discharge damages. To put the FED into practical use under the circumstances that such damages occur, it is required to absolutely prevent discharge from occurring over a long period of time. However, this is very difficult to realize.

Thus, it becomes important to take measures to reduce discharge current so that discharge damages will not occur or can be suppressed to a negligible level even if discharge occurs. As a technique for this end, a technique is known which segments a metal back (generally the anode electrode) into plural regions. The metal back segmentation is roughly classified into one-dimensional segmentation in which the metal back is segmented only in one direction into rectangular metal back segments and two-dimensional segmentation in which the metal back is segmented in two directions into island metal back segments. In the two-dimensional segmentation, the discharge current can be made smaller than in the one-dimensional segmentation. The present invention relates to the two-dimensional segmentation. Although illustrations of examples of known techniques concerning the one-dimensional segmentation are omitted, the basic configuration is disclosed in JP-A No. 10-326583 (KOKAI). The two-dimensional segmentation is disclosed in JP-A No. 10-326583 (KOKAI) (embodiment 9), JP-A No. 2001-243893 (KOKAI), and JP-A No. 2004-158232 (KOKAI).

With the metal back segmentation, it is required to secure a path of beam current to suppress a reduction in brightness to an allowable level and to prevent discharge due to a potential difference produced across the split gap at the time of discharge. As for these requirements, JP-A No. 10-326583 (KOKAI) and JP-A No. 2004-158232 (KOKAI) disclose a configuration such that a resistance layer is formed between metal back segments. In addition, JP-A No. 2001-243893 (KOKAI) discloses a configuration such that each of the metal back segments is connected through a resistance layer to a nearby voltage supply line. Although no embodiment of two-dimensional segmentation is illustrated, the formation of a resistance layer between metal back segments is also disclosed in JP-A No. 2000-251797 (KOKAI).

With the conventional techniques to segment the metal back, there are three problems: (1) to reduce the discharge current below the allowable level; (2) to reduce a reduction in brightness below the allowable level, the reduction in brightness due to a decrease in the anode voltage that occurs due to resistance across the gap; and (3) to prevent discharge due to a voltage produced across the gap in the period of discharge. The configuration disclosed in JP-A No. 2001-243893 such that each of the metal back segments is connected to a voltage supply line is subject to limitations from a viewpoint of reducing of discharge current. Hereinafter, therefore, we will explain the conventional problems supposing the configuration as disclosed in JP-A Nos. 10-326583 and 2004-158232 in which a resistance layer is formed between metal back segments.

From the viewpoint of the above problem (1), it is required to increase the resistance Rg across the gap. On the other hand, from the viewpoint of the problems (2) and (3), it is required to, in contrast, decrease the resistance Rg across the gap. Thus, there is a trade-off relationship between the problem (1) and the problems (2) and (3) and it is difficult to make them compatible with each other.

### BRIEF SUMMARY OF THE INVENTION

The present invention has been made to solve the above problems and its object is to provide an image display device which achieves a decrease of discharge current while suppressing a reduction in brightness.

We earnestly accumulated examinations of the resistance Rg between the segmented matal back layers in order to solve the problem (1) and the problems (2) and (3) between which a trade-off relationship exists. In detail, the resistance Rg comprises a gap resistance Rx in the X direction (the direction perpendicular to the scanning direction: typically, the horizontal direction in which RGB pixels are arranged) and a gap resistance Ry in the Y direction (the scanning direction: typically, the vertical direction). There is a degree of freedom of optimization of each of the Rx and Ry. However, as the result of our examinations, when it is desired to make the discharge current particularly small, it became clear that mere adjustment of the gap resistances Rx and Ry may make it difficult to meet the problems (1), (2) and (3) at the same time. As the second best policy, therefore, we examined the provision of a low-resistance material in the right places on the voltage supply lines and consequently came to complete the invention.

An image display device of the present invention comprises a front plate having phosphor layers, resistance layers formed between the phosphor layers, a matal back layer which is formed on the phosphor layers and the resistance layers and segmented into regions by gaps Gx in a first direction X perpendicular to the scanning direction for image display and by gaps Gy on the resistance layers in a second direction Y which coincides with the scanning direction for image display, and high-voltage supply means which applies a high voltage to the matal back layer, and a back plate which is set opposite to the front plate and has a number of electron emitting elements arranged on it and is characterized in that the resistance layer present between each region segmented by the gaps Gy is discretely formed in its portions with low-resistance regions which are relatively lower in resistance than the other portions.

The low-resistance regions can be formed of a different material from the other regions. In this case, it is desirable to form the low-resistance regions by adding a low-resistance material to the material of the other regions. For example, by dispersing an appropriate amount of particles of a good conductor, such as indium tin oxide (ITO), in the low-resistance regions, these regions can be made lower in resistance than the peripheral other regions (the high-resistance regions containing particles of RuO₂ or the like).

In addition, it is desirable that a common electrode connected to a high-voltage supply means be placed outside the area in which the phosphor layers are formed and connected through a connecting resistance to a portion of the segmented matal back layer. Furthermore, the connecting resistance may be formed by forming the low-resistance regions up to the common electrode. Moreover, to lower the resistance, the both-side voltage supply system may be used in which the common electrode comprises a pair of electrodes to supply voltage to the matal back layer from both sides of the second direction Y. The connecting resistance is inserted between the common electrode and the low-resistance regions. In the present invention, the common electrode is not an integral part but an arbitrary part. This is because, considering the ultimate voltage supply circuit, the high-voltage terminal can be used as the common electrode as it is and the common electrode can be omitted.

Here, the definition of the scanning direction will be described. Hereinafter, X and Y will be described in terms of typical directions. In the FED, scanning lines extending in the X direction and modulation lines extending in the Y direction are formed in a matrix form to perform the so-called simple matrix drive. In this case, each of the scanning lines is supplied with a scanning signal in sequence in the Y direction in, for example, 1/60 seconds and, when a scanning signal is being applied to a scanning line, modulation signals for pixels corresponding to that scanning line are applied to the modulation lines. Considering voltage supply in the front plate, trying to supply voltage from the X direction requires supplying current to pixels corresponding to a scanning line at the same time and this is inefficient. For this reason, voltage supply from the Y direction is advantageous in terms of efficiency. In association with such a technical background, the present invention refers to X and Y. X and Y are typically the horizontal direction and the vertical direction, respectively. However, in general, X and Y are not subject to such a limitation but may be set to the vertical direction and the horizontal direction, respectively.

In this specification, the gaps in the segmented matal back layer are not limited to ones formed by removing portions of the matal back layer and include ones formed by modifying portions of the matal back layer with a process, such as oxidation, so as to increase resistance.

### BRIEF DESCRIPTION OF THE SEVERAL VIEWS OF THE DRAWING

FIG. 1 is a schematic perspective view of an image display device (FED);

FIG. 2 is an enlarged sectional view of an end portion of the image display device taken along line II-II of FIG. 1;

FIG. 3 is an enlarged plan view of the phosphor screen of an image display device according to a first embodiment of the present invention;

FIG. 4 is a process diagram illustrating a method of manufacturing the image display device of the first embodiment;

FIG. 5 is an enlarged plan view of the phosphor screen of an image display device according to a second embodiment of the present invention; and

FIG. 6 is an enlarged plan view of the phosphor screen of an image display device according to a third embodiment of the present invention.

### DETAILED DESCRIPTION OF THE INVENTION

The best modes for carrying out the invention will be described hereinafter with reference to the accompanying drawings.

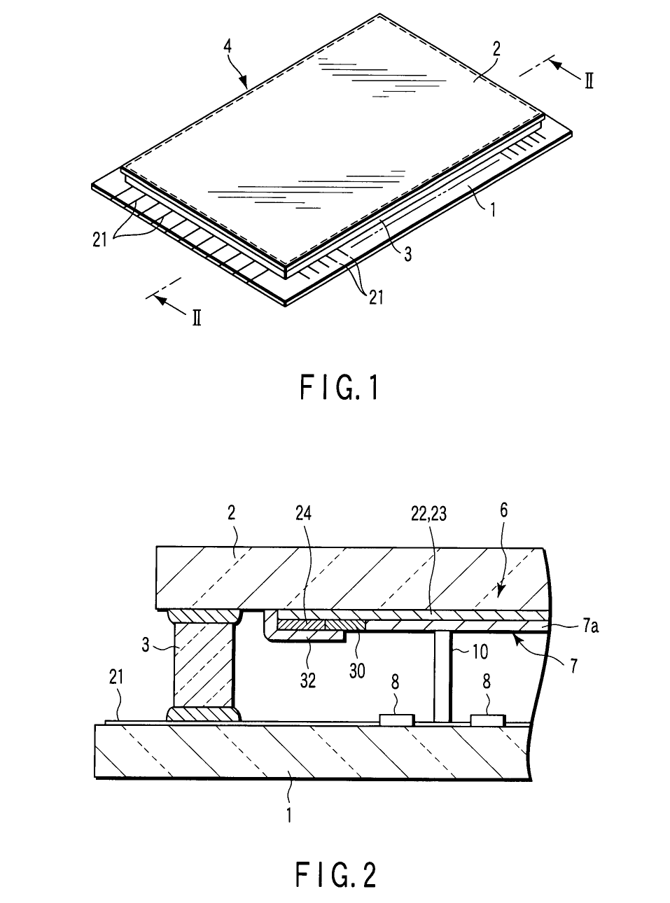

FIGS. 1 and 2 show the structure of an FED which is common to the embodiments. The FED has a front plate 2 and a back plate 1 each of which consists of glass in the shape of a rectangle. Both the plates 1 and 2 are placed to face each other with a spacing of 1-2 mm therebetween. The front plate 2 and the back plate 1 have their peripheral portions bonded together through a sidewall 3 in the shape of a rectangular frame to form a flat and rectangular vacuum envelope 4 the inside of which is maintained at a high vacuum of about 10⁻⁴ Pa or below.

A phosphor screen 6 is formed on the inner surface of the front plate 2. This phosphor screen 6 is composed of phosphor layers 23 that emit light of three colors of red (R), green (G), and blue (B) and a light-tight layer 22 in the form of a matrix. The phosphor screen 6 is formed on top with a matal back layer 7 which functions as an anode electrode and as a light reflecting film to reflect light from the phosphor layers 23. At the time of a display operation, the matal back layer 7 is impressed with a given anode voltage by a voltage supply circuit having a common electrode 24. The matal back layer 7 is formed by a thin-film process, such as vapor deposition. Since the phosphor screen 6 has irregularities, direct deposition of the matal back layer 7 onto the phosphor screen 6 results in failure to form a mirror surface. For this reason, for example, a smoothing process is performed by sticking of a resin film and then Al is vapor deposited. The matal back layer 7 is composed of a number of segmented regions 7a. The segmented regions 7a of the matal back layer are arranged in the form of a matrix to correspond to face to face pixels consisting of the RGB phosphor layers 23.

The common electrode 24 is made of a conducting material and formed by screen printing of a metallic paste of, for example, Ag. Each of the segmented regions 7a of the matal back layer is electrically connected to the common electrode 24 through a connecting resistor 30. Such a structure suppresses damages due to discharge that occurs between the phosphor screen 6 and the back plate 1. In addition, the common electrode 24 is coated with an insulating or high-resistance coating material 32 to prevent the occurrence of discharge between the common electrode 24 and the back plate 1. The coating material 32 is formed by means of, for example, screen printing using low-melting-point glass or low-melting-point glass dispersed with particles of a resistance adjustment material, for example.

On the other hand, the back plate 1 is formed on its inner surface with a large number of electron emitting elements 8 which emit electron beams to excite the phosphor layer 23. These electron emitting elements 8 are arranged in columns and rows to face to face each of the pixels on the phosphor screen 6 and driven by interconnect lines (not shown) arranged in a matrix form. In addition, a large number of plate- or pillar-like spacers 10 are set as reinforcement at regular intervals between the back plate 1 and the front plate 2 in order to withstand atmospheric pressure acting on the plates 1 and 2.

With such a image display device, the phosphor screen 6 is impressed through the matal back layer 7 with an anode voltage Va and electron beams emitted from the electron emitting elements 8 are accelerated by the anode voltage Va to strike the phosphor screen 6. Thereby, corresponding phosphor layers 23 emit light to display a desired image.

### First Embodiment

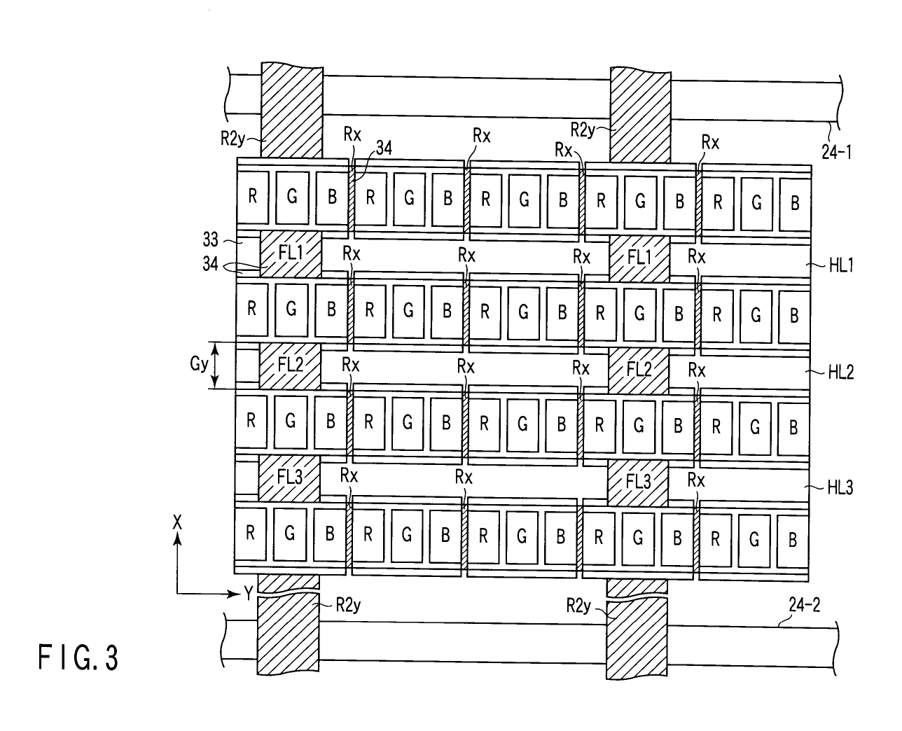

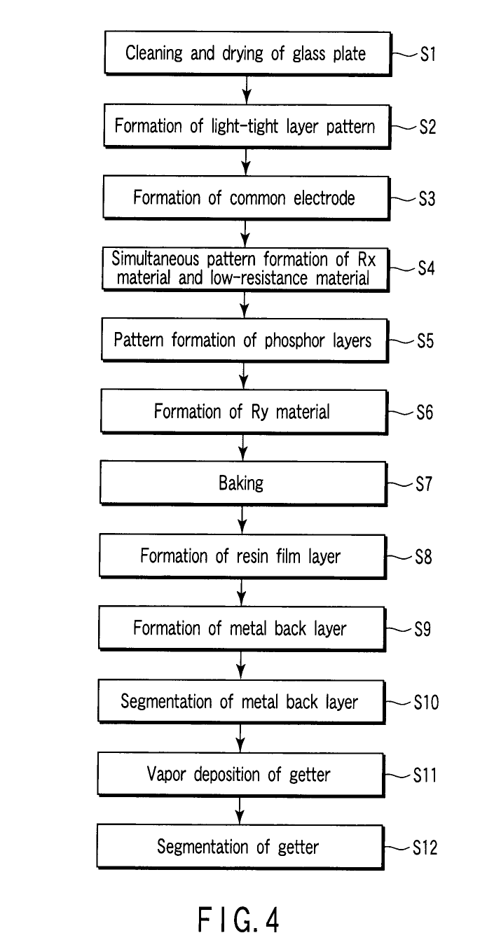

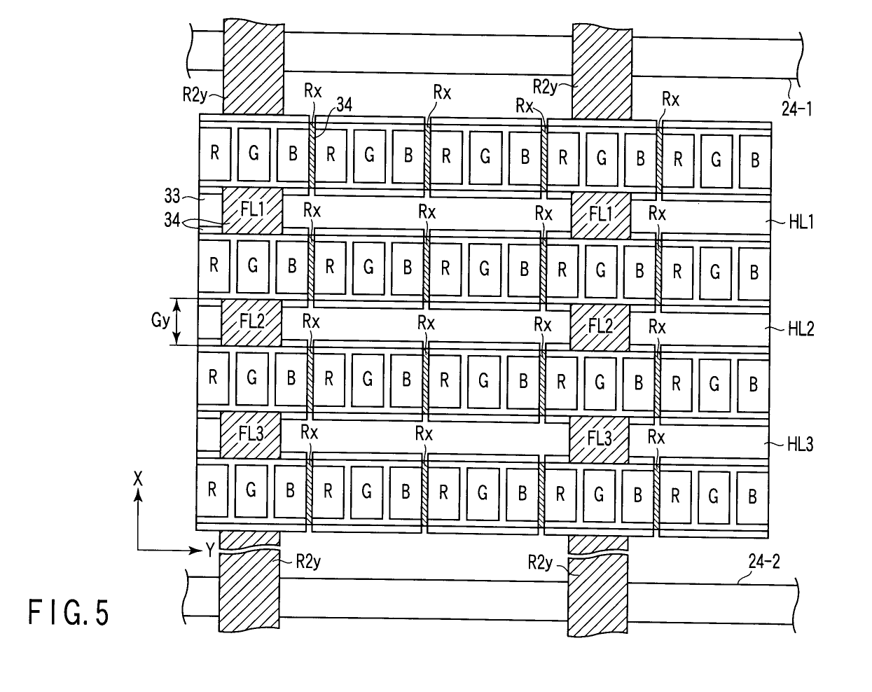

A first embodiment of the present invention will be described next with reference to FIGS. 3 and 4.

In the first embodiment, connecting resistances R2y consisting of a low-resistance material 34 are connected to pixels at intervals. In gaps Gy, low-resistance regions FL1, FL2, FL3, . . . , FLn consisting of a low-resistance material 34 are placed discretely in high-resistance regions consisting of a high-resistance material 34. A cut off interval resistance Rx consisting of the low-resistance material 34 is placed between each of the horizontally arranged pixels. Specifically, first and second voltage-supply lines are separated from each other so that three columns of pixels are interposed therebetween as opposed to providing a voltage-supply line for each pixel column as in the conventional technique. Though not shown, following the second voltage-supply line the third through n-th voltage-supply lines are also placed at intervals of three pixel columns. These discretely placed voltage-supply lines are connected to a pair of upper and lower common electrodes 24-1 and 24-2.

Seeing in the Y direction, in the gaps Gy, low-resistance regions FL1 are formed at intervals of three pixel columns on the horizontal line HL1 in the first row. Low-resistance regions FL2 are formed at intervals of three pixel columns on the horizontal line HL2 in the second row. Low-resistance regions FL3 are formed at intervals of three pixel columns on the horizontal line HL3 in the third row. Seeing in the X direction, on the other hand, the low-resistance regions FL1, FL2, FL3-FLn are placed serially in the vertical direction (X direction). Though not shown, the low-resistance regions following the third row are likewise placed serially in the vertical direction.

The common electrodes 24-1 and 24-2 are connected to a high-voltage voltage supply (not shown) through appropriate voltage application means (not shown).

Although this embodiment assumes the configuration of both-side voltage supply which supplies voltage from the upper and lower common electrodes, use may be made of a single-side voltage supply system which supplies voltage from either the upper side or the lower side. However, with the both-side voltage supply, the amount ΔVa by which the anode voltage is lowered can be made to be ¼ of that of the single-side voltage supply; therefore, from a brightness improvement viewpoint it is preferable to use the both-side voltage supply system.

In the above embodiment, the pitch of the low-resistance portions is set to the space of three pixels. In general, however, it is only required to select the optimum pitch taking into consideration specifications, such as a given beam current, a discharge current, a reduction in brightness, etc. Making the pitch too large will increase too much the amount of current the low-resistance portions carry, which will results in a problem of an increase in discharge current in the neighborhood of the low-resistance portions. According to the results of our examination of restrictions on the pitch, it is desirable that the pitch of the low-resistance portions be in a range of 2-10 division units (segments). It is desirable to select the pitch in a range of less than 20 division units (segments) at most. Here, the division unit corresponds to one pixel in this embodiment. In general, it is possible to make the division unit larger or smaller than one pixel. For example, it is also possible to set a pair of R and G or five subpixels of RGBRG as the division unit (single segment).

Next, a process of manufacturing the image display device of the invention will be described with reference to FIG. 4.

The glass plate 2 serving as the front plate of the FED is cleaned using a given chemical and then dried to obtain a clean surface (step S1). A light-tight layer forming solution containing a light-absorbing substance, such as a black pigment, is applied to the clean inner surface of the front plate 2. After having been baked, the applied layer is exposed to light using a mask having openings in positions corresponding to a matrix pattern and then developed to form the light-tight layer 22 of the matrix pattern (step S2). The thickness of the light-tight layer 22 is set to 2 μm, for example.

Next, the common electrodes 24-1 and 24-2 are pattern formed on the upper and lower sides of the light-tight layer 22 (step S3). The common electrodes 24-1 and 24-2 are formed by means of screen printing of Ag paste, for example.

Next, a pattern (Rx and FL1 to FLn) of the low-resistance material 34 is formed on the light-tight layer 22 by means of the photolithographic method. As the low-resistance material 34 use may be made of a paste containing, for example, 10-40 mass % of particles of a good conductor, such as indium tin oxide (ITO). The average diameter of ITO particles is, say, 10 to 90 nm. Its burning temperature can be set to, say, 450±50° C.

Assuming an FED for a typical large TV set, the sheet resistance of the high-resistance material is set to a range of, say, 10⁵ to 10⁸Ω/□ and that of the low-resistance material is set to a range of 10⁴ to 10⁶Ω/□. In this embodiment, for example, the sheet resistance is set to about 1×10⁵Ω/□ for the low-resistance material and to about 5×10⁵Ω/□ for the high-resistance material.

Next, a mixed solution in which red (R) phosphor particles are mixed in a predetermined percentage in a solution of photoresist (containing a solvent) is applied by the spincoating method to the front plate 2 at a given thickness. After having been dried by heating, the applied layer is exposed using a screen mask having openings in positions corresponding to the red (R) patterns and then developed. For green (G) and blue (B) as well, the same photolithographic method is used to form predetermined patterns (step S5). Finally, the plate 2 is baked to obtain the phosphor screen 6 in which the phosphor layers 23 of rectangular tricolor patterns are arranged regularly in the vertical and horizontal directions. For example, with square pixels of a pitch of 600 μm, the width of the horizontal separation line (stripe) of the phosphor layer 23 is set to a range of, say, 200 to 400 μm. The light-tight layer 22 is preset under the vertical and horizontal separation lines. The thickness of the phosphor layers 23 is set to, for example, 5 to 15 μm. The phosphor layers 23 may overlap with the light-tight layer 22.

Next, the cut off interval resistances Ry consisting of the high-resistance material 33 of a desired pattern are formed in the gaps Gy by means of the photolithographic method (step S6). As the high-resistance material 33 use may be made of a paste containing particles of a suitable resistance material, such as RuO₂. After the formation of the cut off interval resistances, baking is done by heating to a predetermined temperature (step S7). The baking temperature can be set to, say, 450±50° C.

The low-resistance regions FL1-FLn may be formed by adding a different low-resistance material to the high-resistance regions. In this case, the order of steps S4 and S6 is simply reversed to make the high-resistance regions first.

Next, a resin film layer is formed on the phosphor layers 23 and the resistance materials 33 and 34 (step S8). This resin film layer is a thin film consisting of an organic resin, such as nitrocellulose, which is formed by the spincoating method, for example.

Next, aluminum is deposited onto the resin film by means of the vacuum deposition method to form the matal back layer 7 of a predetermined thickness (step S9). Furthermore, this is heated to a predetermined temperature to burn off the resin film layer.

Next, the matal back layer 7 is segmented using predetermined a segmenting means into a two-dimensionally segmented matal back layer 7a (step S10).

Next, the front plate 2 thus formed is placed within a vacuum chamber together with the back plate 1 formed with electron emitting elements and a given getter material consisting of Ti or Ba is vapor deposited from above the pattern to form a vapor deposited film of the getter material not shown in an area of the matal back layer 7 (step S11). In forming such a getter film, in order to prevent gaps in the matal back layer from being rendered conducting by the getter material, the low-resistance material forming the gap portions is given a function of electrically segmenting the vapor deposited film. Alternatively, a film having a getter segmenting function is formed in addition to the resistance material (step S12). A technique to segment the getter by surface irregularities is known as described in, for example, JP-A No. 2003-068237.

Finally, the front plate and the back plate are bonded together using a suitable sealing material to form a vacuum vessel. It is desirable to integrate the sidewall 3 with the back plate 1 or the front plate 2 in advance at a proper time and bond the sidewall 3 to the back plate 2 or the front plate 1.

### Second Embodiment

Next, a second embodiment of the present invention will be described with reference to FIG. 5. Description of parts for which this embodiment corresponds to the abovementioned embodiment is omitted.

In the phosphor screen of this embodiment, the cut off interval resistances Rx are formed by a different process and a different material from those for the voltage supply lines. That is, the sheet resistance of the cut off interval resistances Rx is set to the order of 5×10⁵Ω/□, higher than that in the first embodiment (of the order of 1×10⁵Ω/□). By so doing, although the steps increase in number, the optimum resistance settings can be made, thus allowing more desirable characteristics to be obtained.

The manufacturing method of the second embodiment is the same as that of the first embodiment except for addition of a step of forming a resistance material and thus the detailed description thereof is omitted.

### Third Embodiment

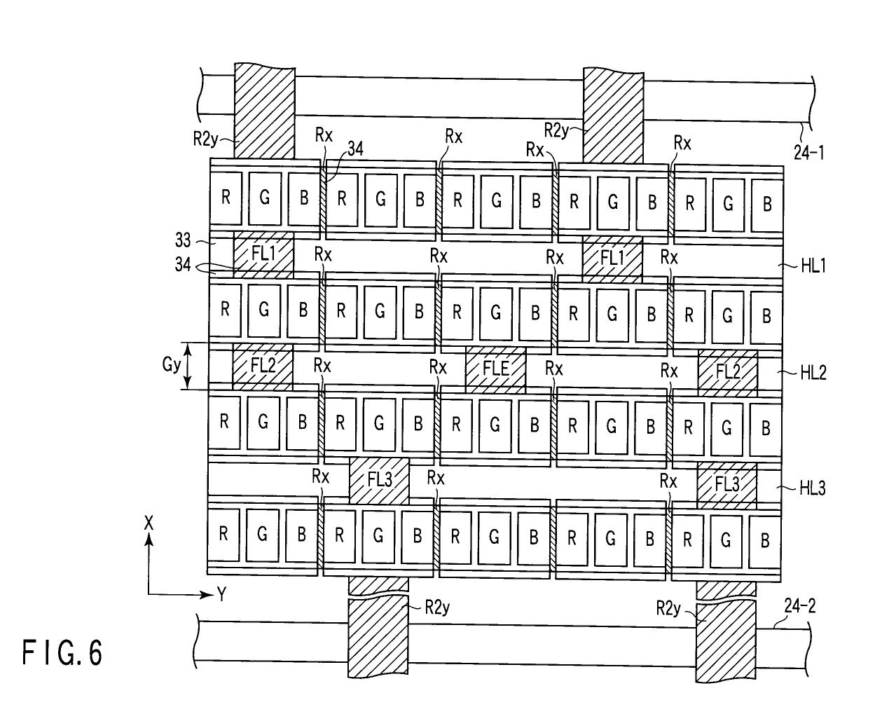

Next, a third embodiment of the present invention will be described with reference to FIG. 6. Description of parts for which this embodiment corresponds to the abovementioned embodiments is omitted.

In the third embodiment, the low-resistance region FL3 on the horizontal line HL3 of the third row is shifted by one pixel in the Y direction (scanning direction) from the vertically arranged low-resistance regions FL1 and FL2 on the lines HL1 and HL2 of the first and second rows. In addition, in the second supply line as well, the low-resistance region FL1 on the horizontal line HL1 of the first row is shifted by one pixel in the Y direction from the vertically arranged low-resistance regions FL2 and FL3 on the lines HL2 and HL3 of the second and third rows.

Furthermore, an extra low-resistance region FLE is also placed on the line HL2 of the second row in a position between the first and second supply lines. This extra low-resistance region FLE is placed at an equal distance from each of the first and second supply lines and supplied with voltage power from both the supply lines.

Thus, it is possible not only to place the low-resistance regions at regularly spaced intervals but also to form them into complicated patterns. The principles of the invention increase the degree of freedom in optimization. In general, therefore, it is only required to select the optimum pattern under given conditions.

According to the present invention, since low-resistance regions are formed discretely in portions of a high-resistance layer which is present between each of regions segmented by gaps Gy, discharge current can be reduced with a decrease in brightness due to an anode voltage drop ΔVa suppressed.

What is claimed is:

1. An image display device which comprises a front plate having phosphor layers, resistance layers formed between the phosphor layers, a matal back layer which is formed on the phosphor layers and the resistance layers and segmented into regions by gaps Gx in a first direction X perpendicular to the scanning direction for image display and by gaps Gy on the resistance layers in a second direction Y which coincides with the scanning direction for image display, and high-voltage supply means which applies a high voltage to the matal back layer, and a back plate which is set opposite to the front plate and has a number of electron emitting elements arranged on it, wherein the resistance layer present between each region segmented by the gaps Gy is discretely formed in its portions with low-resistance regions which are relatively lower in resistance than the other portions.

2. The image display device according to claim 1, wherein the low-resistance regions are formed of a different material from the other portions.

3. The image display device according to claim 1, wherein the low-resistance regions is formed by adding a low-resistance material.

4. The image display device according to claim 1, wherein a common electrode connected to the high-voltage supply means is placed outside the region formed with the phosphor layers and is connected to a part of the segmented matal back layer through a connecting resistance.

5. The image display device according to claim 4, wherein the connecting resistance is formed by forming the low-resistance regions up to the common electrode.

6. The image display device according to claim 4, wherein the common electrode comprises a pair of electrodes to supply voltage to the matal back layer from both sides in the second direction Y.
